(19) United States
(12) Patent Application Publication
(10) Pub. No.: US 2009/0204713 A1
(43) Pub. Date: Aug. 13, 2009

(54) UNIT AND A METHOD FOR DEFINING A SESSION RULE IN A NETWORK

(75) Inventors: Nathalie Beziot, Le Plessis Robinson (FR); Matthieu Smessaert, Charenton Le Pont (FR); Steve Tsang-Kwong-U, Meudon (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 12/305,153

(22) PCT Filed: Jun. 15, 2007
(86) PCT No.: PCT/FR2007/051443

§ 371 Date: Dec. 16, 2008

(30) Foreign Application Priority Data
Jun. 16, 2006 (FR) 0652525

(51) Int. Cl. G06F 15/16

(52) U.S. Cl. 709/228

(57) ABSTRACT

A unit is provided for defining a rule to be applied to a multimedia session in a network. The unit takes into account, to define the rule, information data about the media, a policy predefined by the carrier and an access type received from a session monitoring unit and used by a terminal participating in the session to access the network.

### CROSS-REFERENCE TO RELATED APPLICATIONS

This Application is a Section 371 National Stage Application of International Application No. PCT/FR2007/051443, filed Jun. 15, 2007 and published as WO 2007/144545 on Dec. 21, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of differentiating quality of service (QoS) in telecommunications networks.

As is known in the art, the object of this mechanism is to optimize the resources of the access network by allocating them to the applications that have the greatest need for them.

Although this is not limiting on the invention, it applies in particular to mobile telecommunications networks, in particular to the Universal Mobile Telecommunications system (UMTS) defined by the Third Generation Partnership Project (3GPP).

The disclosure applies also to fixed networks defined in the framework of the ETSI's Telecoms & Internet converged Services & Protocols for Advanced Networks (TISPAN) project.

As is known in the art, to set the maximum quality of service authorized for a session, the policy control mechanism defined by the 3GPP standard makes mutually consistent the requirements of an application, the conditions of a subscription entered into by a user, and the policy of a telecommunications carrier.

The disclosure finds a preferred application in networks conforming to the TISPAN or to IP Multimedia Subsystem (IMS) architecture, for example introduced in version 5 and subsequent versions of the UMTS.

These architectures set up dynamically and control multimedia sessions between two users employing the UMTS packet domain as a transport network.

### BACKGROUND OF THE DISCLOSURE

FIG. 1 represents a mobile network 1 with a packet domain 101 and an IP multimedia subsystem 102.

The packet domain 101 is inherited from the GPRS. It enables a mobile equipment 10 to access a packet-switched network via a mobile access network 103.

The packet domain 101 includes a Serving GPRS Support Node (SGSN) and a Gateway GPRS Support Node (GGSN).

As is known in the art, the SGSN is connected to the Radio Network Controller (RNC). It controls the terminals 10 present in its control area.

The GGSN serves as an interface with external data networks.

In the IP multimedia subsystem 102 there are different SIP session control nodes:
Proxy-Call State Control Functions (P-CSCF) are the first points of contact for a terminal equipment 10 in the IMS domain; in version 5 of the UMTS, the P-CSCF included a resource control node responsible for determining the maximum quality of service (QoS Max) authorized for an IMS session; in version 5 of the UMTS, this resource control node was called the Policy Decision Function (PDF); in version 6, the PDF was an entity separate from the P-CSCF but retained the same functions; it was renamed in version 7;
Serving Call State Control Functions (S-CSCF) control the sessions of a terminal 10 throughout the period in which it is registered in the IMS domain;
Interrogating Call State Control Functions (I-CSCF) are the entry points of an IMS domain for IMS sessions between a user in that IMS domain and a user in another IMS domain.

The S-CSCFs have an interface with the Home Subscriber Server (HSS), that was introduced in version 5 of the UMTS, and that constitutes a development of the Home Location Register (HLR) containing functions relating to the IP multimedia domain. This HSS entity contains the database of IMS subscribers.

In a fixed network, the IP multimedia subsystem can be connected to other access networks, for example a WiFi network as defined by the IEEE 802.11 standard or an Asynchronous Digital Subscriber Line (ADSL) network.

The Session Initiation Protocol (SIP) is used to control IP multimedia sessions. It is used by the terminal equipments 10, the CSCF entities, and the application servers.

A terminal equipment 10 uses the SIP to establish a session in the IMS domain.

The terminal 10 first sets up a primary context PDP (Packet Data Protocol) control session at the GPRS level and a radio channel to register with the home location register (HLR) and forward the SIP signaling.

The terminal 10 is then registered in the IMS domain in order to discover its P-CSCF and S-CSCF.
Once the mobile is registered in the IMS domain, it can initiate a media session with another user or with a server.

To this end, the terminal equipment sends the P-CSCF an SIP INVITE message that is forwarded to the S-CSCF and thereafter to the destination network.

In this INVITE message, among other things, the terminal equipment 10 describes the media type (video, audio, codec supported, quality of service characteristics necessary for the application, including bit rate information, etc.) that it requires for a given service.

The resource control node uses this service information to calculate the maximum quality of service (QoS Max) authorized for each of the media of the session.

After a general step of negotiating media and media parameters, the terminal equipment 10 initiates the allocation of resources in the UMTS packet domain by activating a secondary context PDP in order to transport the media.

On reception of the secondary context PDP activation request, the GGSN obtains from the PDF the information QoS Max about the maximum quality of service authorized for the terminal equipment for this session.

In other words, in the current state of the art, the PDF calculates the maximum authorized quality of service QoS Max from the information in the SIP IMS signaling about the media and codecs negotiated.

This mechanism for allocating the maximum authorized quality of service (QoS Max) does not offer sufficient granularity to define a strategy for allocating resources between all a carrier's access systems.

It is assumed here that the user of the mobile terminal 10 has a subscription compatible with at least one other type of access and authorizing them to use a High-Speed Downlink Packet Access (HSDPA) bit rate and decides to set up a session including a single mail-type medium to access their electronic mail via a mail server.

In a manner that is known in the art, if at the time of negotiation the user is located in a geographical area that does not offer sufficient HSDPA resources, but only EDGE (2G) access, the user is entitled to the highest possible bit rate in that cell, i.e. 250 kbit/s.

Now, for an EDGE cell, it would be desirable, for a mail service, to limit this bit rate to 50 kbit/s.

This will not happen because the resource control node does not have the information about the user's access type for defining the rules that fix the maximum bandwidth allocated to a medium in the network.

Similarly, a metering control node called the Charging Rule Function (CRF) entity or Policy and Charging Rule Function (PCRF) entity, depending on the version of the UMTS, that defines the metering rules used with a view to billing use of a medium is not able, in the current state of the art, to take into account the type of access of the terminal 10 to the network to define these rules.

### SUMMARY

A first aspect of the disclosure relates to a unit for controlling sessions using media in a telecommunications network, said control unit including means for extracting information data on each medium from a request to initiate said session received from a terminal and means for generating and sending a message including said information data on each medium to a unit for defining a rule to be applied to said session.

According to an embodiment of the invention, said extraction means extract an access type from a header of said request, said terminal participating in said session uses said access type to access said network, and said generation and sending means insert said access type into a field of said message including said information data on the medium.

A second aspect of an embodiment of the invention relates to a unit for defining a rule to be applied to sessions using media in a telecommunications network. This rule definition unit includes:
means for receiving information data on each medium from a control unit of the session;
means for defining the rule using the information data and a predefined policy; and
means for sending the rule to a unit responsible for applying the rule.

According to an embodiment of the invention, in order to define the rule, said rule definition unit also takes account of an access type that is used by a terminal participating in the session to access the network.

In a particular embodiment, the access type is received from the session control unit.

In a variant, the access type is received from a GGSN gateway node.

In one particular embodiment, the means for defining said rule of the rule definition unit define the rule by combining the access type and the maximum bit rate authorized for the medium, the maximum bit rate being part of the information data received from the control unit.

This particular embodiment advantageously defines the above-mentioned rule taking account of the maximum authorized bit rate for a medium, and therefore adds additional granularity introducing differences for the same access type.

It therefore becomes possible, for example for 3G-type access, to define a different rule for fixing the maximum quality of service allocated to a medium according to whether the bit rate requested is of UTRAN or HSDPA type.

In one particular embodiment, the control unit is a P-CSCF entity as defined in the IMS architecture.

In one particular embodiment of the invention, the rule definition unit is a CRF unit of the IMS architecture, the above-mentioned rule being a metering rule used for billing the medium, and the unit responsible for applying that rule is a GGSN of the IMS architecture.

This particular embodiment of the invention therefore obtains metering information enabling each of the media used in a session to be billed taking account of the access type of a terminal to the network in addition to the service information data.

In another particular embodiment of the invention, the rule definition unit is a PDF unit of the IMS architecture, the rule is a rule for fixing a maximum quality of service allocated to a medium, and the unit responsible for applying that rule is a GGSN of the IMS architecture.

This feature advantageously allocates each of the media the maximum quality of service that allows for the access type of a terminal to the network.

In one particular embodiment, the control unit includes means for communicating with the terminal using the SIP. This unit obtains the access type with which the terminal accesses the network from a field of an SIP INVITE request.

Alternatively, the control unit of an embodiment of the invention obtains the above-mentioned access type from another entity of the network, for example from the GGSN.

In a correlated way, an embodiment of the invention relates to a method of controlling sessions using media in a telecommunications network, said method including a step of extracting information data on each medium from a request to initiate said session received from a terminal and a step of generating and sending a message including said information data on each medium to a unit for defining a rule to be applied to said session.

According to an embodiment of the invention, said control method is characterized in that:
said extraction step extracts from a header of said request an access type which said terminal participating in said session uses to access said network; and
said generation and sending step inserts said access type in a field of said message including said information data on the medium.

An embodiment of the invention relates further to a method of defining a rule to be applied to sessions using media in a telecommunications network.

This method includes:
a step of receiving information data on each medium from a control unit of said session;
a step of defining the rule using the information data; and
a step of sending the rule to a unit responsible for applying said rule.

According to an embodiment of the invention, said rule definition step takes account of an access type that is used by a terminal participating in the session to access the network.

In one particular embodiment, the various steps of the control method and/or the rule definition method are determined by computer program instructions.

Consequently, an embodiment of the invention is also directed to a computer program on an information medium, adapted to be executed in a computer, and including instructions adapted to execute the steps of a control method and/or a rule definition method as described above.

This program can use any programming language and take the form of source code, object code or a code intermediate between source code and object code, such as a partially-compiled form, or any other desirable form.

An embodiment of the invention is also directed to a computer-readable information medium containing instructions of a computer program as referred to above.

The information medium can be any entity or device capable of storing the program. For example, the medium can include storage means, such as a ROM, for example a CD ROM or a microelectronic circuit ROM, or magnetic storage means, for example a floppy disk or a hard disk.

Moreover, the information medium can be a transmissible medium such as an electrical or optical signal, which can be routed via an electrical or optical cable, by radio or by other means. The program of an embodiment of the invention can in particular be downloaded over an Internet-type network.

Alternatively, the information medium can be an integrated circuit incorporating the program and adapted to execute the method in question or to be used in its execution.

### BRIEF DESCRIPTION OF THE DRAWINGS

Other features and advantages emerge from the description given below, with reference to the appendices and to the appended drawings, which show one non-limiting embodiment of the invention.

FIG. 1, already described, shows the architecture of a prior art IMS network;

FIG. 2 is a diagram showing a session control unit of one particular embodiment of the invention;

FIG. 3 is a diagram showing a rule definition unit of one particular embodiment of the invention;

FIG. 4 is a flowchart showing the main steps of a session control method of one particular embodiment of the invention;

FIG. 5 is a flowchart showing the main steps of a rule definition method of one particular embodiment of the invention; and

FIG. 6 is a diagram showing a mechanism of interaction between a control unit and a rule definition unit of one particular embodiment of the invention.

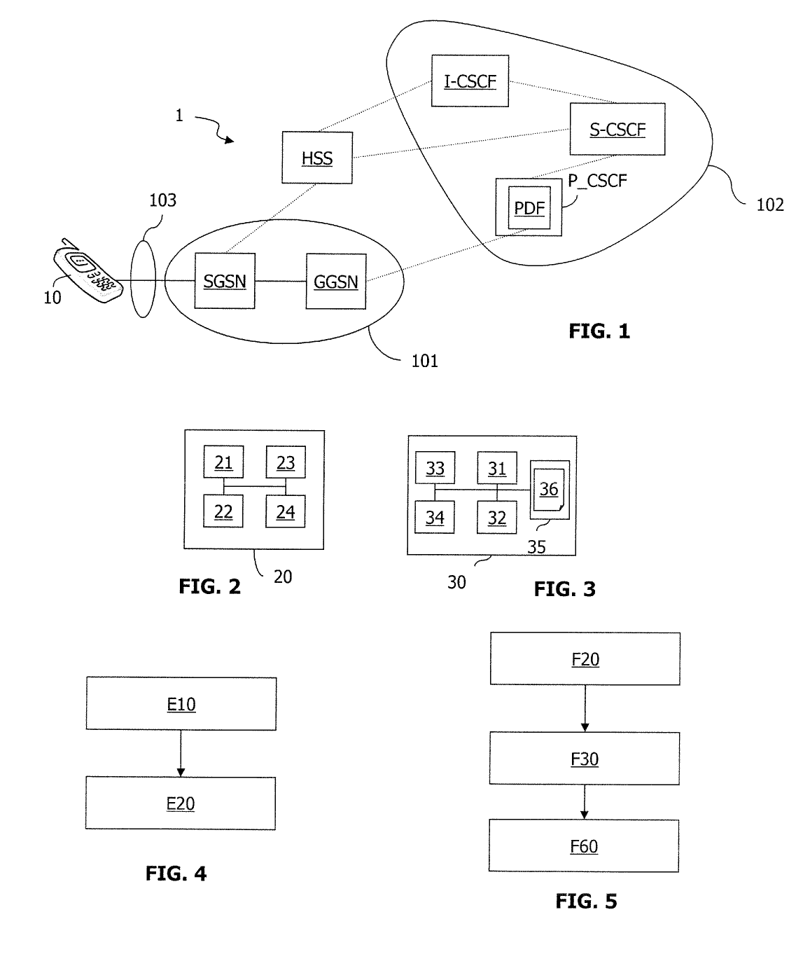

### DETAILED DESCRIPTION OF ILLUSTRATIVE EMBODIMENTS

### 1. Detailed Description of One Embodiment

FIG. 2 is a diagram showing a session control unit 20 of an embodiment of the invention.

In the example described here, this control unit 20 consists of a P-CSCF entity as defined in the IMS architecture. This entity has the hardware architecture of a conventional computer. It includes a processor 21, a random-access memory (RAM) 22, a read-only memory (ROM) 23, and communication means 24.

The read-only memory 23 includes a computer program including instructions for executing a control method of an embodiment of the invention the main steps of which are shown by the FIG. 4 flowchart.

FIG. 3 is a diagram showing a rule definition unit 30 of an embodiment of the invention.

In the example described here, this control unit is a PCRF entity as defined in the IMS architecture.

This rule definition unit 30 has the hardware architecture of a conventional computer.

It includes a processor 31, a random-access memory 32, a read-only memory (ROM) 33, and communication means 34.

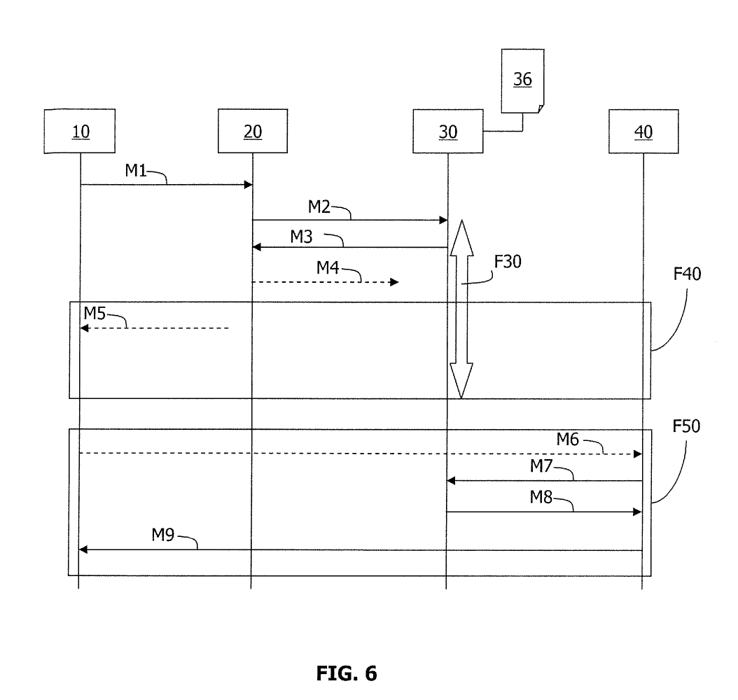

The read-only memory 33 stores a computer program including instructions for executing a rule definition method of an embodiment of the invention the main steps of which are shown by the FIG. 5 flowchart.

The FIG. 3 rule definition unit 30 also includes a hard disk drive 35 storing a configuration file 36 in which the carrier defines, for two media (mail and video), a policy for defining:
the metering rule used for billing each of these media; and
the rule for fixing the maximum quality of service allocated to each of the media.

Below, there follows a description with reference to FIG. 6 of a mechanism for interaction between the session control unit 20 of FIG. 2 and the rule definition unit 30 of FIG. 3, as takes place when setting up a session to set up a mobile terminal 10 in the IMS domain on the UMTS network.

It is assumed first that the mobile terminal 10 is registered in the IMS domain. To initiate a session with another user or with an application server, the mobile terminal 10 sends an SIP INVITE request (M1) to the P-CSCF entity 20 of an embodiment of the invention.

This request is received by the P-CSCF 20 of an embodiment of the invention in a step E10 of the rule definition method of an embodiment of the invention.

As known in the art, this INVITE request includes, in a format compatible with the Session Description Protocol (SDP), the media type (video, audio, codec, quality of service characteristics necessary for the application, including bit rate information, etc.) required by the mobile terminal 10 for this session.

In the embodiment described here, the INVITE request also includes the access type which the mobile terminal 10 uses to access the network. As known in the art, and as described in the document 3GPP TS 24.229, the access type is entered in one of the SIP headers of the request, i.e. a location of the INVITE request totally separate from that storing the information data on each protocol in a format specified by the SDP.

In one embodiment of the invention, the INVITE request includes a network access type parameter.

Alternatively, the session control unit obtains the access type used by the terminal 10 to access the network from the GGSN during the same step E10.

During a step E20 of the control method of an embodiment of the invention, the control unit 20 sends the rule definition unit 30 information data on each media and the access type referred to above in a message M2 (see FIG. 6).

The PDF entity 30 of an embodiment of the invention receives this data during a step F20 of the rule definition method of an embodiment of the invention.

Appendix A shows the content of this message M2.

The parameters of this message, with the exception of the last line, are defined in the 3GPP specifications.

To be more specific, the parameters relating to the metering rules for billing (charging aspect) are defined in the document TS29.211 and the parameters relating to quality of service in the document TS29.209.

This message advantageously includes a final field CH (see appendix A) in which the session control unit 20 indicates to the rule definition unit 30 the access type that the terminal 10 uses to access the network.

In one particular embodiment of the invention a message sent by a P-CSCF entity to a PDF, CRF or PCRF entity in an IMS architecture includes a field storing the access type used by a mobile terminal to access the network.

The message M2 is received correctly by the rule definition unit 30 during a step F20 of the rule definition method of an embodiment of the invention.

This reception step is followed by a step during which the rule definition unit 30 sends the session control unit 20 an acknowledgement message M3.

During the next step, the session control unit 20 sends the SS-CSCF entity, in the form of a message M4, the SIP INVITE message received in the step E10, which message is then forwarded to the destination chosen by the mobile terminal 10.

As soon as the message M2 is received (step F20), the rule definition unit 30 begins to define the rules to be applied to the session using the information data, the definition policy for those rules, and the access type received from the session control unit 20.

This step F30 of defining rules continues throughout a general step of negotiating media and media parameters to be used in the session.

For example, during this general negotiation phase, it may be decided that only one voice type medium and a particular codec will be used during the session, although the mobile terminal 10 had initially specified a multimedia, voice+video session.

As known in the art, the first message M5 received by the mobile terminal 10 during this negotiation phase E40 is a 183_session_progress type message containing a token used afterwards to refer to this negotiation.

To define the rules that must apply to the session, the rule definition unit 30 uses during the rule definition step F30 the configuration file 36 whose pseudo-code is shown in Appendix B.

In the example described here, this file stipulates that if the mobile terminal 10 accesses the network using the HSDPA protocol, the rule definition unit 30 defines the following two rules:
the metering rule used for billing the mail service is 1 Euro per minute; and
the maximum bandwidth (QoS) allocated to the mail service is 384 kbit/s.

In one embodiment of the invention a configuration file 16 taking account of the access type a terminal uses to access the network is present in a rule definition unit, for example a PDF, CRF or PCFF unit of the IMS architecture.

After the general negotiation step F40 there begins a step F50 of activating a secondary context PDP.

During this activation step F50, the mobile terminal 10 sends a message M6 to the entity responsible for applying the predefined rules (the GGSN entity in an IMS context), that message M6 including the token received by the mobile terminal 10 in the message M5 at the beginning of the negotiation phase E40.

On reception of this secondary context PDP activation request M6, the GGSN 40 extracts the token and forwards it to the PCRF 30 to recover the rules previously defined that take account of the access type that the mobile terminal 10 uses to access the network.

On reception of this request M7, the PCRF 30, in a step F60, sends the rules defined during the definition step F30 to the unit 40 responsible for applying those rules.

The GGSN 40 then sends a secondary context PDP activation message M9 to the mobile terminal and media can be exchanged between the mobile terminal 10 and the third-party device.

Although the present disclosure has been described with reference to one or more examples, workers skilled in the art will recognize that changes may be made in form and detail without departing from the scope of the disclosure and/or the appended claims.

### 2. Appendix A

Appendix A shows the format of a message sent by a session control unit to a rule definition unit in one particular embodiment of the disclosure.

| | Attribute Name | Reference | Comments |
|---|---|---|---|
| | Abort-Cause | 3GPP TS 29.209 [4] | |
| | AF-Application-ID | 3GPP TS 29.209 [4] | |
| | AF-Charging-ID | 3GPP TS 29.209 [4] | |
| | Flow-Description | 3GPP TS 29.209 [4] | |
| | Flow-Number | 3GPP TS 29.209 [4] | |
| | Flows | 3GPP TS 29.209 [4] | |
| | Flow-Status | 3GPP TS 29.209 [4] | |
| | Flow-Usage | 3GPP TS 29.209 [4] | |
| | Flow-Grouping | 3GPP TS 29.209 [4] | |
| | Max-Requested-Bandwidth- | 3GPP TS 29.209 [4] | |
| | DL | | |
| | Max-Requested-Bandwidth- | 3GPP TS 29.209 [4] | |
| | UL | | |
| | Media-Component- | 3GPP TS 29.209 [4] | |
| | Description | | |
| | Media-Component-Number | 3GPP TS 29.209 [4] | |
| | Media-Sub-Component AVP | 3GPP TS 29.209 [4] | |
| | Media-Type | 3GPP TS 29.209 [4] | |
| | RR-Bandwidth | 3GPP TS 29.209 [4] | |
| | RS-Bandwidth | 3GPP TS 29.209 [4] | |
| | SIP-Forking-Indication | 3GPP TS 29.209 [4] | |
| | Specific-Action | 3GPP TS 29.209 [4] | Allowed values: |
| | | | INDICATION_OF_{—} |
| | | | TERMINATION_OF_BEARER(4) |
| | | | INDICATION_OF_ESTABLISHMENT |
| | | | OF BEARER (5) |
| | Subscription-Id | RFC 4006 [8] | Subscription identification (IMSI, |
| | | | MSISDN, etc.) |
| CH | ACCESS TYPE | | |
| → | | | |

### 3. Appendix B

Appendix B shows, in pseudo-code, the content of a configuration file of a rule definition unit of an embodiment of the disclosure.

If Media = mail

If Access-Type = 3G

If Bit rate type requested = UTRAN

QoS Max = 64 kbit/s
Charging = 0.5 euro/minute

If Bit rate type requested = HSDPA

QoS Max = 384 kbit/s
Charging = 1 euro/minute

If Access-Type = 2G

QoS Max = 50 kbit/s
Charging = 0.5 euro/minute

If Media = video

If Access-Type = 3G

If Bit rate type requested = UTRAN

QoS Max = 384 kbit/s
Charging = 1 euro/minute

If Bit rate type requested = HSDPA

QoS Max = 650 kbit/s
Charging = 1.5 euro/minute

If Access-Type = 2G

QoS Max = 250 kbit/s
Charging = 0.75 euro/minute

1-14. (canceled)

15. A rule definition unit for defining a rule to be applied to sessions using media in a telecommunications network, this rule definition unit including:
means for receiving information data on each medium from a control unit of said session;
means for defining said rule using said information data and a predefined policy; and
means for sending said rule to a unit responsible for applying said rule;
wherein, in order to define said rule, the rule definition unit also takes account of an access type received from said session control unit that is used by a terminal participating in said session to access said network.

16. A rule definition unit according to claim 15, wherein said access type is received from the session control unit.

17. A rule definition unit according to claim 15, wherein said access type is received from a GGSN gateway node.

18. A rule definition unit according to claim 15, wherein said means for defining said rule define said rule by combining said access type and a maximum bit rate authorized for said medium, said maximum bit rate being part of said information data received from said control unit.

19. A rule definition unit according to claim 15, wherein the unit comprises a CRF unit of an IMS architecture and said rule comprises a metering rule used for billing said medium.

20. A rule definition unit according to claim 15, the unit comprises a PDF unit of an IMS architecture and said rule comprises a rule for fixing the maximum quality of service allocated to said medium.

21. A rule definition unit according to claim 15 for defining two rules, wherein the unit comprises a PCRF unit of an IMS architecture and said rules comprise:
a metering rule used for billing said medium; and
a rule for fixing the maximum quality of service allocated to said medium.

22. A method of defining a rule to be applied to sessions using media in a telecommunications network, said method including:
a step of receiving information data on each medium from a control unit of said session;
a step of defining said rule using said information data, a predefined policy, and an access type that is used by a terminal participating in said session to access said network; and
a step of sending said rule to a unit responsible for applying said rule.

23. A computer program including instructions, stored on a computer-readable storage medium, for executing steps of a rule definition method defining a rule to be applied to sessions using media in a telecommunications network when said program is executed by a computer, wherein the method comprises:
receiving information data on each medium from a control unit of said session;
defining said rule using said information data, a predefined policy, and an access type that is used by a terminal participating in said session to access said network; and
sending said rule to a unit responsible for applying said rule.

24. A storage medium readable by a computer storing a computer program including instructions for executing a rule definition method defining a rule to be applied to sessions using media in a telecommunications network when said program is executed by a computer, wherein the method comprises:
receiving information data on each medium from a control unit of said session;
defining said rule using said information data, a predefined policy, and an access type that is used by a terminal participating in said session to access said network; and
sending said rule to a unit responsible for applying said rule.
